(19) United States
(12) Patent Application Publication
(10) Pub. No.: US 2013/0192220 A1
(43) Pub. Date: Aug. 1, 2013

(54) ENERGY EFFICIENT OFFSHORE WIND TURBINES

(71) Applicants: Arunvel THANGAMANI, Chennai (IN); Bapiraju Vvn JAMPANA, Chennai (IN)

(72) Inventors: Arunvel THANGAMANI, Chennai (IN); Bapiraju Vvn JAMPANA, Chennai (IN)

(73) Assignee: GAMESA INNOVATION & TECHNOLOGY, S.L., Sarriguren (Navarra) (ES)

(21) Appl. No.: 13/363,828

(22) Filed: Feb. 1, 2012

(51) Int. Cl. F02G 1/043; F02G 1/053

(52) U.S. Cl. 60/517

(57) ABSTRACT

An in-built energy conservation device has been described for offshore turbines. The energy conservation device includes a heat engine and a generator. The heat engine extracts a portion of heat energy from a coolant flowing the through the wind turbine. The heat engine further converts the heat energy into the mechanical energy. The generator converts the mechanical energy into the electrical energy. The electrical energy is further used for the operation of at least one of a heat exchanger unit and an air treatment plant present in the offshore wind turbine. The energy conservation device further includes an inlet. The inlet allows the passage of treated air through the energy conservation device for thermal conditioning of the treated air. The thermal conditioning makes up for the thermal losses of the treated air while passing though a plurality of flow lines within a wind turbine tower.

### FIELD OF THE INVENTION

The present invention generally relates to an energy saving device for a wind turbine system, and more particularly to, the energy saving device extracting heat from the power electronics systems in the wind turbine system in an energy efficient manner.

### BACKGROUND OF THE DISCLOSURE

A wind turbine converts the kinetic energy of wind into electrical energy which is then sent to a substation at a wind farm. Generally, in a wind turbine, the nacelle houses components and various systems necessary for converting the mechanical energy into electricity. The components may range from heavy duty generators, gearboxes, brakes and transformers to small power electronic components. The small power electronic components may include conversion systems consisting semi conductors such as insulated gate bipolar transistors (IGBTs), Insulated gate commutative transistors, thyristors etc. These systems and components generate a significant amount of heat inside the nacelle. In the currently installed offshore platforms, they are expected to generate up to 300 kW of heat. Controlling the temperature of electrical and mechanical heat generating components—particularly during operation of the components—has always been a problem and especially within the art of wind turbines, this problem has been profound.

The current wind turbines employ two methods of cooling mechanism. First method includes the use of surrounding air. The wind turbine nacelle may include multiple ventilation ducts which can allow the surrounding air to pass through the nacelle and may help in the cooling of the components present within the nacelle. Second method may use a liquid coolant. There are certain areas within the nacelle which cannot be cooled by air. This method uses the circulation of liquid coolant from the heat producing area inside the nacelle. The liquid coolant can extract a portion of heat and pass it back to a heat exchanger. The heat exchanger may further cool the liquid coolant using ambient air or sea water and re-circulate the liquid coolant.

In the offshore platforms, the surrounding air entering the nacelle is saline air. The saline air normally causes corrosion of the metallic components present inside the nacelle. This reduces the life of the offshore wind turbines from 25-30 years to 15-20 years. Thus, an air treatment plant can be used for the dehumidification and the desalination of the surrounding air. The treated air then further can be supplied to the nacelle through a separate duct. Normally, the air treatment plant is placed at the base of the wind turbine tower structure. Therefore, the air treatment plant requires a blower to blow the treated air to the nacelle present at the top. The operation of the blower and the air treatment plant normally consumes a lot of electrical power. It impacts the overall wind turbine efficiency negatively. While various methods have been developed in the past for the saving of the energy, there is still room for development. Thus a need persists for further contributions in this area of technology.

### SUMMARY OF THE DISCLOSURE

The above-mentioned shortcomings, disadvantages and problems are addressed herein which will be understood by reading and understanding the following specification.

The present invention is directed to energy savings device for a wind turbine system. One illustrative embodiment of the present disclosure includes an energy saving device integrated with a power electronics systems of an off-shore wind turbine. The energy saving device includes a heat engine, a coupled generator, provisions for entry and exit for the liquid coolant and provisions for entry and exit of cooling air, the heat engine configured to extract a first portion of the heat energy from a liquid coolant coming out of the power electronics systems, the energy saving device delivering the liquid coolant with reduced temperature to a heat exchanger located external to the power electronics systems, the heat exchanger configured to extract the rest of the heat energy, the heat engine further configured to convert the first portion of heat energy into the mechanical energy. The coupled generator configured to convert the mechanical energy from the heat engine into electrical energy, the electrical energy being used for operating at least one of the heat exchanger, and at least one blower configured to blow the air from the air treatment plant at the tower base to the nacelle. The inlet configured to allow the passage of the treated air through the energy saving device for the thermal conditioning to make up for the thermal losses of the treated air while passing though a plurality of flow lines within the tower.

The present invention is also directed to an energy efficient wind turbine consisting at least one energy saving device integrated with the power electronics of the wind turbine. The energy saving device configured to extract a portion of heat from the power electronics and converting the portion of heat into a usable form.

Others will become apparent to those skilled in the art upon consideration of the following detailed description of illustrative embodiments exemplifying the best mode of carrying out the invention as presently perceived.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a front view of a wind turbine according to an embodiment of the disclosure;

FIG. 2 is a side view of the wind turbine described in the embodiment of the FIG. 1;

FIG. 3 is a side view of the wind turbine along with a converter cabinet and a heat exchanger unit according to an embodiment of the disclosure;

FIG. 4 is a schematic view of energy conservation device along with the converter cabinet of the wind turbine described in the embodiment of FIG. 1;

FIG. 5 is a perspective view of the converter cabinet along with the inbuilt energy conservation device of the wind turbine described in the embodiment of FIG. 1; and

FIG. 6 is the block diagram showing connection between the energy conservation device and other components of the wind turbine.

### DESCRIPTION OF PREFERRED EMBODIMENTS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

The present invention is directed to energy savings device for a wind turbine system. One illustrative embodiment of the present disclosure includes an energy saving device integrated with a power electronics systems of an off-shore wind turbine. The energy saving device includes a heat engine, a coupled generator, provisions for entry and exit for the liquid coolant and provisions for entry and exit of cooling air, the heat engine configured to extract a first portion of the heat energy from a liquid coolant coming out of the power electronics systems, the energy saving device delivering the liquid coolant with reduced temperature to a heat exchanger located external to the power electronics systems, the heat exchanger configured to extract the rest of the heat energy, the heat engine further configured to convert the first portion of heat energy into the mechanical energy. The coupled generator configured to convert the mechanical energy from the heat engine into electrical energy, the electrical energy being used for operating at least one of the heat exchanger, and at least one blower configured to blow the air from the air treatment plant at the tower base to the nacelle. The inlet configured to allow the passage of the treated air through the energy saving device for the thermal conditioning to make up for the thermal losses of the treated air while passing though a plurality of flow lines within the tower.

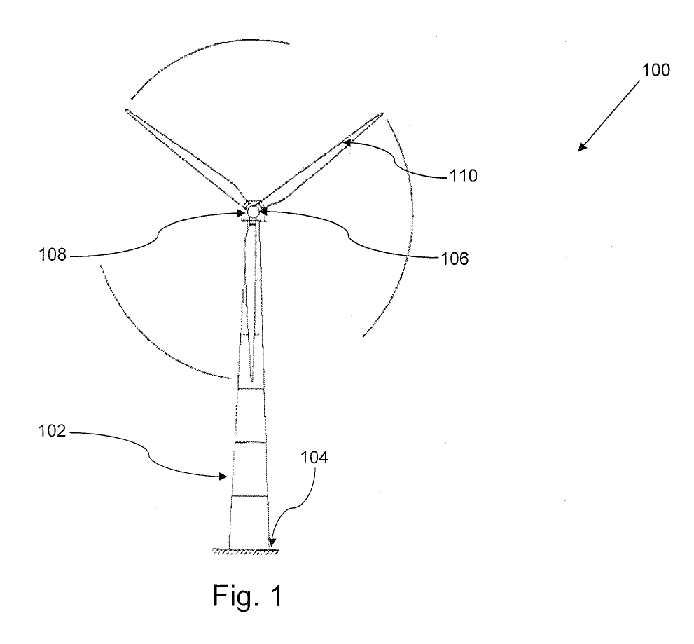

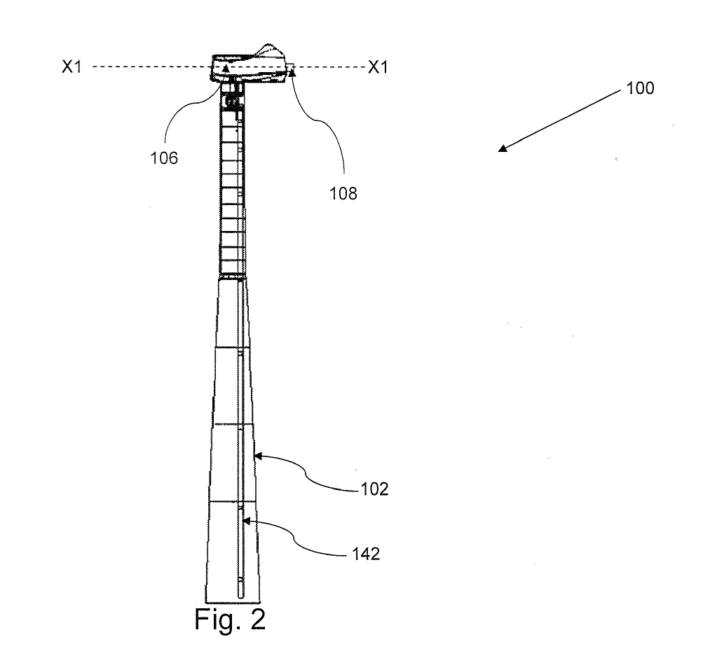

FIG. 1 is a perspective front view showing a wind turbine 100 according to an illustrative embodiment of the disclosure. FIG. 2 is a perspective side view of the wind turbine 100 described in the embodiment of FIG. 1. It should be appreciated that the wind turbine 100 is an offshore wind turbine 100. The illustrated wind turbine 100 includes a wind turbine tower (hereinafter referred to as “tower”) 102 vertically erected on a foundation 104 or a base 104 on land or off-shore, a nacelle 106 mounted at the upper end of the tower 102, and a rotor head 108 mounted at the front end of the nacelle 106 so as to be supported rotatably about the substantially horizontal lateral rotation axis X1-X1 thereof. The rotor head 108 has a plurality of wind turbine blades 110 (for example, three as shown in FIG. 1) mounted in a radial pattern about its rotation axis X1-X1. Thus, the power of wind blowing against the wind turbine blades 110 from the direction of the rotation axis X1-X1 of the rotor head 108 is converted to motive power that rotates the rotor head 108 about the rotation axis X1-X1. An anemometer (not shown in the figure) that measures the wind speed value in the vicinity and an anemoscope (not shown) that measures the wind direction are disposed at appropriate locations of the outer peripheral surface (for example, at the top, etc.) of the nacelle 106.

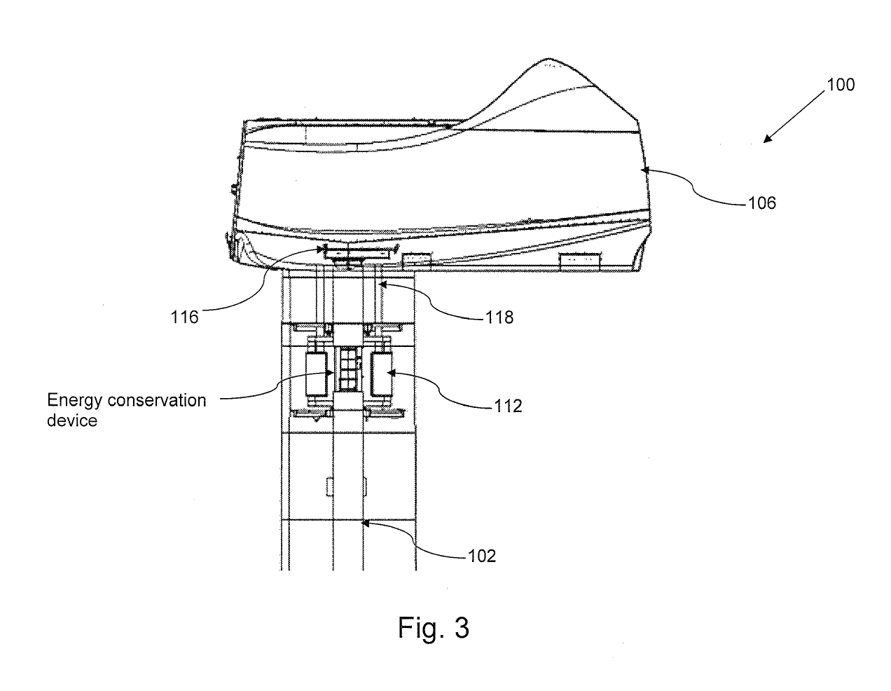

According to an illustrative embodiment of the disclosure, the wind turbine 100 further includes a converter cabinet 112, an in built energy conservation device 114, a heat exchanger unit 116 and a liquid coolant line 118 passing through the converter cabinet 112, the energy conservation device 114 and the heat exchanger unit 116 as shown in FIG. 3. In a preferred embodiment of the disclosure, the energy conservation device 114 is an in-built device and integrated with the converter cabinet 112. The energy conservation device 114 is also be used as an energy saving device 114 or an energy extracting device 114.

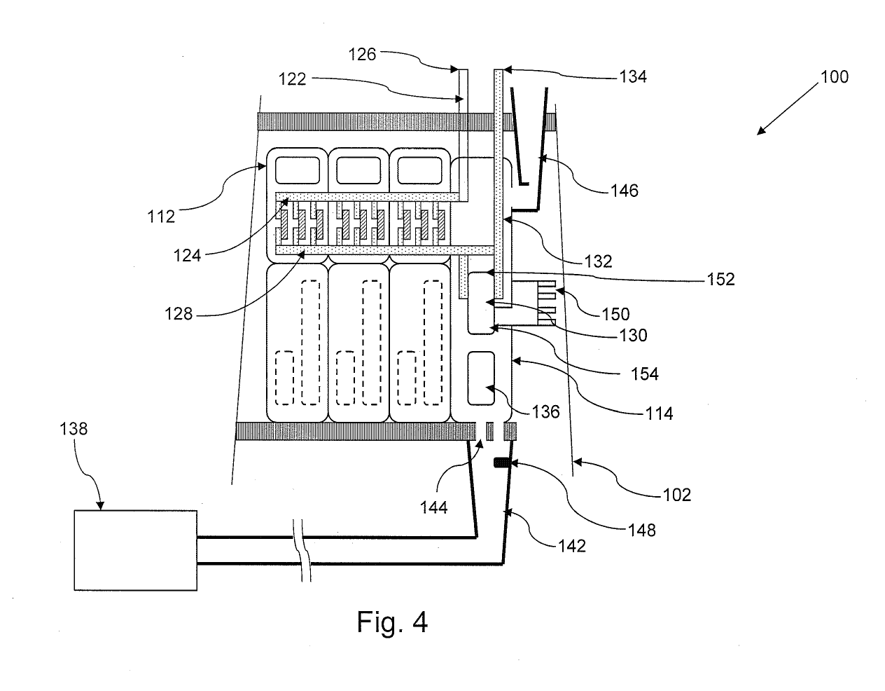

The converter cabinet 112 mainly includes a conversion system i.e. converters and inverters. The converter cabinet 112 includes a plurality of power electronic components 120 such as Insulated gate Bipolar transistor (IGBT), Insulated gate commutative transistors (IGCT), thyristors etc. The plurality of power electronic components 120 are the major source of total heat energy generated by the wind turbine 100. The converter cabinet 112 is present within the tower 102 of the wind turbine 100 as shown in FIG. 4. In an embodiment of the disclosure, the power electronics conversion system is expected to emit out up to 300 kW heat. In order to remove this emitted heat energy, the cooling design using a coolant 122 is being deployed in the wind turbine 100. The coolant 122 flows in the liquid coolant line 118 flowing through a closed circuit involving the converter cabinet 112, the energy conservation device 114, and the heat exchanger unit 116. The heat exchanger unit 116 is used to cool down the coolant 122 so that the coolant 122 may be used again for additional recirculation.

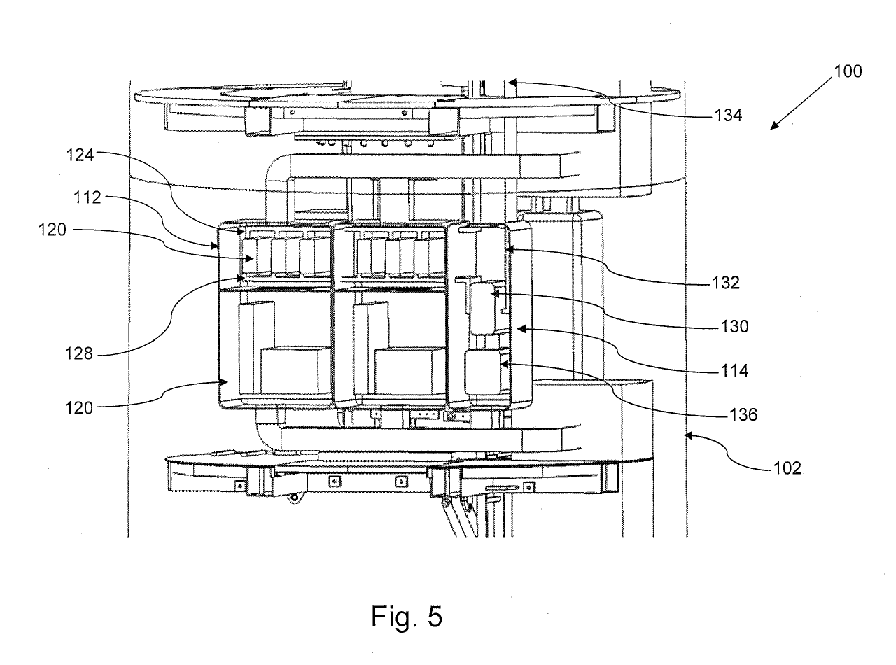

In operation, the coolant 122 enters the converter cabinet 112 through a first coolant line 124 at a first point 126 as shown in FIGS. 4 and 5. The coolant 122 entering at the first point 126 is the cold coolant. The coolant 122 then passes through the plurality of power electronic components 120. At this point, the coolant 122 extracts the heat energy emitted by the plurality of power electronic components 120, which results in increase of temperature of the coolant 122. The coolant 122 then passes through a second coolant line 128 carrying the hot coolant. The hot coolant now passes through a heat engine 130 of the inbuilt energy conservation device 114. The heat engine 130 extracts a first portion of the heat energy from the hot coolant. This results in the decrease in temperature of the hot coolant. The hot coolant then exits out of the converter cabinet 112 through a third coolant line 132 at a second point 134.

The coolant 122 after passing through the third coolant line 132 goes to the heat exchanger unit 116 as shown in FIG. 4. The heat exchanger unit 116 extracts the second portion of heat energy from the coolant 122. The output from the heat exchanger unit 116 then again provided to the first coolant line 124 in the form of cold coolant, which further goes back in to the converter cabinet 112 to repeat the whole operation mentioned above. In an embodiment of the disclosure, the water glycol mixture is used as coolant. In another embodiment of the invention the cooling medium could be any kind of frost-proof water or brine, ammoniac, CO2, Freon gases or any other kind of liquid or gas suitable for transporting heat in the closed circuit.

The energy conservation device 114 includes the heat engine 130 and a coupled generator 136 as shown in FIG. 4. The heat engine 130 is configured to convert the first portion of heat energy extracted from the coolant 122 in to the mechanical energy. According to an illustrative embodiment of the disclosure, the heat engine 130 can be a Stirling engine 130. The output of Stirling engine 130 is given to the coupled generator 136. The coupled generator 136 converts the mechanical energy in to the electrical energy in usable form.

The Stirling engine 130 is an external combustion engine having a high theoretical heat efficiency which periodically heats and cools the operation fluid sealed in an operation chamber to change the state, and takes out the rotational energy from a high heat source by utilizing the change in the state. In an internal combustion engine such as a gasoline engine or a diesel engine, a fuel is intermittently burned in the air which is an operation fluid. In the Stirling engine which is an external combustion engine, unlike an internal combustion engine, heat produced by the continuous combustion is transmitted to the operation fluid to heat it offering an advantage in that the state of burning the fuel can be easily controlled producing less harmful exhaust components such as NOx, CO and the like. Not being limited to the heat produced by the combustion, further, this engine makes it possible to utilize various kinds of heat sources such as the heat generated by the nacelle in current embodiment of the disclosure, and has excellent features from the standpoint of saving energy and environmental friendliness, too.

The coupled generator 136 is a standard electric generator which converts the mechanical energy in to electrical energy. A typical generator works on the principle of Faraday's Law of electromagnetic Induction. The use of any other type of electric generator is well within the scope of this disclosure. The electric generator makes use of the mechanical energy generated by the Stirling engine 130 to produce the electric energy. It should be appreciated that the coupled generator 136 is different from the major generator present inside the nacelle 106.

The electric energy generated by the energy conservation device 114 is used for various purposes in the wind turbine 100. It should be appreciated that the electric energy can be used for the operation of heat exchanger unit 116.

According to the current embodiment of the disclosure, the energy conservation device 114 also helps in the designing of the smaller and cost effective heat exchanger unit 116. Once the coolant 122 passes through the energy conservation device 114, the temperature of coolant 122 also reduces. Thus, the heat exchanger unit 116 now needs to be designed for the cooling of the coolant 122 with lesser temperature as compared to the coolant which were used in the prior art without the energy conservation device 114. As a universal law, once the heat rejection rate decreases, the heat exchanger unit 116 surface area also decreases, which in turn reduces the electrical input required for the operation of the heat exchanger unit 116. And finally as a result, the size reduction also decreases the overall cost of manufacturing of the heat exchanger unit 116.

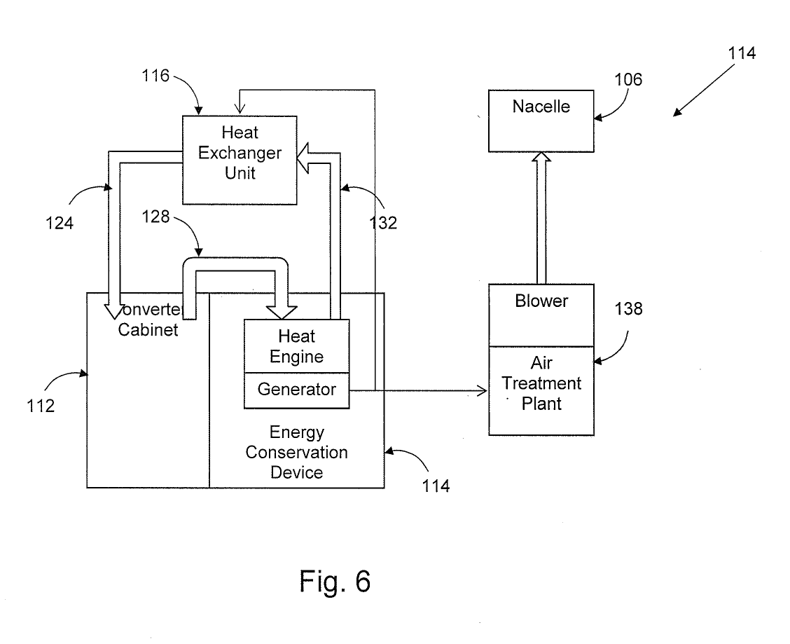

According to an illustrative embodiment of the disclosure the nacelle 106 of the wind turbine 100 can also be cooled by an air cooling mechanism. The air cooling mechanism makes use of the surrounding air for the cooling of the nacelle 106. The air cooling mechanism includes an air treatment plant 138, at least one blower 140 and a plurality of ducts 142 as shown in FIG. 4 and block diagram of FIG. 6. In the offshore platforms, the surrounding air is saline and humid, which causes corrosion to the components present within the nacelle 106 and converter cabinet 112. The air treatment plant 138 is present on the base 104 of the wind turbine 100 within the tower 102. The air treatment plant 138 is configured to dehumidify and desalinate the surrounding air. Since the air treatment plant 138 is present at the base 104 and the height of tower 102 could be up to 130 meters, therefore, we require blower 140 to pump the treated air at the top of the tower 102.

The dehumidified and desalinated air then sent to the blower 140 and the blower 140 blows the air at the top of the tower to the nacelle 106 through the plurality of ducts 142. It should be appreciated that electrical energy generated by the coupled generator 136 may also be used for the operation of the air treatment plant 138 and the blower 140 as shown in the block diagram of FIG. 6. Thus, the wind turbine 100 making use of the electrical energy generated by the energy conservation device 114 to operate at least one of the air treatment plant 138, the heat exchanger unit 116 and the blower 140. The electrical energy is normally connected to a power supply unit (not shown) of the heat exchanger 116.

According to another illustrative embodiment of the current disclosure, the energy conservation device 114 further includes an entry point 144 present at the bottom side as shown in FIG. 4. The entry point 144 allows the treated air to pass through the energy conservation device 114. Initially, the air treated by the air treatment plant 138 passes through the plurality of flow lines 142 present within the tower 102. There is normally a temperature loss, for example of up to 3-4 degree Celsius, in the treated as the air comes from bottom to top of the tower 102. It is necessary to thermally condition the treated air i.e. to maintain the same temperature of the treated air. This can be achieved by passing the treated air through the energy conservation device 114 as shown in FIG. 4. Finally, after the thermal conditioning, the treated is passed to the nacelle 106 through an exit point 146.

The energy conservation device 114 also includes a plurality of fans 148 at the entry point 144. The plurality of fans 148 regulate the flow of the treated air going into the nacelle 106. As the energy conservation device 114 also emits a portion of heat energy extracted from the heat engine 130, this heat energy helps in increasing the temperature of treated air. Further, with the help of plurality of fans 130, the temperature of the treat air entering the nacelle 106 can be regulated.

The energy conservation device 114 further includes a heat sink 150 as shown in FIG. 4. The heat sink 148 releases the additional heat of the energy conservation device 114 to the environment. In the preferred embodiment of the invention, the Stirling engine 130 has two ends, one is a heat input end 152 and the other one is a mechanical output end 154, out of these two the heat input end 152 is connected to the liquid coolant flow lines coming from the power electronics systems. The heat sink 150 is present on the mechanical output end 154 of the Stirling engine 130. The mechanical output end 154 needs to be kept at a lower temperature, thus a constant temperature difference dT is maintained between the mechanical output end 154 and the heat input end 152. Thus heat sink 150 helps the Stirling engine 130 running continuously on this same temperature difference.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. An energy saving device integrated with a power electronics systems of a wind turbine, the wind turbine having a tower, a nacelle present on top of the tower, a liquid coolant and a heat exchanger, the nacelle receiving a treated air for the cooling of the nacelle from an air treatment plant placed at a base of the tower, the liquid coolant configured to extract a heat energy generated by a plurality of semiconductor components inside the power electronics systems, characterized in that the device comprising:
a heat engine configured to extract a first portion of the heat energy from the liquid coolant coming out of the power electronics system, and delivering the liquid coolant at reduced temperature to the heat exchanger, the heat exchanger configured to extract a second portion of the heat energy, the heat engine further configured to convert the first portion of heat energy into the mechanical energy;
a coupled generator configured to convert the mechanical energy from the heat engine into the electrical energy, the electrical energy output being connected to a power supply unit of the heat exchanger, the electrical energy also operating at least one blower configured to blow the air from the air treatment plant to the nacelle; and
an entry point configured to allow the passage of the treated air through the energy saving device for thermal conditioning, thermal conditioning makes up for the thermal losses of the treated air while passing though a plurality of ducts within the tower

2. The energy saving system of claim 1 characterized in that an exit point configured to deliver the treated air from the energy saving device to nacelle.

3. The energy saving device of claim 1, characterized in that a plurality of fans configured to regulate the flow of treated air entering the energy saving device.

4. The energy saving device of claim 1, characterized in that the device is present as an integrated compartment in the power electronics systems inside the tower.

5. The energy saving device of claim 1, characterized in that the heat engine is a Stirling engine

6. The energy saving system of claim 1 characterized in that a heat sink configured to sink the heat energy of the Stirling engine into the atmosphere.

7. The energy saving system of claim 1, characterized in that the air treatment plant includes at least one of a de-salination unit and a dehumidification unit.

8. The energy saving system of claim 1, characterized in that the heat exchanger is present at the top of the nacelle.

9. The energy saving system of claim 1, characterized in that the wind turbine is an offshore wind turbine.

10. A wind turbine comprising:
an in built energy saving device used with a wind turbine, the wind turbine having a tower placed on a base;
a nacelle present on top of the tower; the nacelle receiving a treated air for the cooling of the nacelle from an air treatment plant placed at the base of the tower
a liquid coolant, the liquid coolant configured to extract a heat energy generated by a plurality of electronic components inside the power electronics systems;
a heat exchanger;
an energy saving device, characterized in that the device comprising:
a heat engine configured to extract a first portion of the heat energy from the liquid coolant coming out of the power electronics systems, the heat engine delivering the liquid coolant with reduced temperature to the heat exchanger, the heat exchanger configured to extract a second portion of the heat energy, the heat engine further configured to convert the first portion of heat energy into the mechanical energy;
a coupled generator configured to convert the mechanical energy from the stirling engine into electrical energy, the electrical energy being used for operating at least one of the heat exchanger and a blower configured to blow the air from the air treatment plant to the nacelle; and
an entry point configured to allow the passage of the treated air through the energy saving device for thermal conditioning, thermal conditioning makes up for the thermal losses of the treated air while passing through a plurality of ducts within the tower.

11. The energy saving system of claim 1 characterized in that an exit point configured to deliver the treated air from the energy saving device to nacelle.

12. The in-built energy saving device of claim 10 is integrated with a power electronics systems of the wind turbine.

13. An energy saving device integrated with a power electronics systems of a wind turbine, the wind turbine having a tower, a nacelle present on top of the tower, a liquid coolant and a heat exchanger, the nacelle receiving a treated air for the cooling of the nacelle from an air treatment plant placed at a base of the tower, the liquid coolant configured to extract a heat energy generated by a plurality of electronic components inside the power electronics systems, characterized in that, the device comprising:
a heat engine configured to extract a first portion of the heat energy from the liquid coolant coming out of the power electronics systems, the heat exchanger configured to extract a second portion of the heat energy from the liquid coolant coming out of the heat engine, the heat engine further configured to convert the first portion of heat energy into the mechanical energy;
a coupled generator configured to convert the mechanical energy from the stirling engine into electrical energy, the electrical energy being used for operating at least one of the heat exchanger and a blower configured to blow the air from the air treatment plant to the nacelle

14. The energy saving system of claim 1, characterized in that an entry point configured to allow the passage of the treated air through the energy saving device for thermal conditioning, thermal conditioning makes up for the thermal losses of the treated air while passing though a plurality of flow lines within the tower.

15. The energy saving system of claim 1, characterized in that a plurality of fans configured to regulate the flow of treated air entering the energy saving device.

16. An energy recovery system configured to be used with a wind turbine for minimizing the electrical energy requirements for functioning of the wind turbine, characterized in that, the energy recovery system comprising:
a plurality of semiconductor components present in a nacelle of the wind turbine releasing heat energy;
a liquid coolant absorbing the heat energy released from the plurality of electronic components in the nacelle;
a blower for supplying a treated air through a duct to the nacelle of the wind turbine;
a heat exchanger for cooling the liquid coolant in the nacelle of the wind turbine;
a Stirling engine, the Stirling engine is converting the heat energy extracted from liquid coolant into the mechanical energy and a coupled generator, the coupled generator converting the mechanical energy to electrical energy,
wherein the electricity generated by the coupled generator is configured to operate at least one of the blower and the heat exchanger.
